(19) United States
(12) Patent Application Publication
(10) Pub. No.: US 2026/0019909 A1
(43) Pub. Date: Jan. 15, 2026

(54) HANDLING PRE-EMPTIVE LOW LATENCY TRAFFIC IN ULTRA-HIGH RELIABILITY

(71) Applicant: SAMSUNG ELECTRONICS CO., LTD., Suwon-si (KR)

(72) Inventors: Abhishek CHATURVEDI, Karnataka (IN); Karthik Srinivasa GOPALAN, Karnataka (IN)

(21) Appl. No.: 19/276,995

(22) Filed: Jul. 22, 2025

Related U.S. Application Data
(63) Continuation of application No. PCT/KR2025/009843, filed on Jul. 8, 2025.

(30) Foreign Application Priority Data
Jul. 10, 2024 (IN) 202441052788
May 22, 2025 (IN) 202441052788

(51) Int. Cl. H04W 36/22; H04W 12/0471; H04W 36/00

(52) U.S. Cl. CPC H04W 36/22; H04W 12/0471; H04W 36/008357

(57) ABSTRACT

Methods include receiving an interrupt request from a second station at a serving access point while ongoing traffic of a first station in an active data session with serving access point on first radio channel or first link. The second station is associated with a pre-emptive higher priority LL traffic compared to the first station. The serving access point determines a second radio channel or the second link for handling ongoing traffic. The second radio channel or the second link is affiliated with an intra-AP MLD and offloading via LLR or affiliated with an inter-AP and offloading via AP level redirection. The serving access point switches the ongoing traffic from a first radio channel or first link to a second radio channel or second link, when the second radio channel or second link is available for handling the ongoing traffic.

### CROSS REFERENCE TO RELATION APPLICATIONS

This application is a continuation application of International Application No. PCT/KR2025/009843, filed on Jul. 8, 2025, in the Korean Intellectual Property Office and claiming priority to, and deriving the benefit of, Indian Provisional Application 20/244,1052788 filed on Jul. 10, 2024 and Indian non-Provisional application No. 202441052788 filed on May 22, 2025, the contents of which is incorporated herein by reference, in its entirety.

### TECHNICAL FIELD

This disclosure relates generally to wireless communication, and more specifically to handling pre-emptive low latency traffic in wireless local area networks (WLANs).

### BACKGROUND

The wireless communication environment is inherently dynamic and unpredictable, often complicated by various types of jamming traffic. These complications are further exacerbated by constraints imposed by existing applications and networking technologies. In particular, there is a significant need for ultra-high reliability wireless communications in critical applications, such as high-security operations and emergency response activities. These applications require dependable communication channels even when subjected to unintentional jamming caused by adverse weather conditions, failures in commercial communications infrastructure, power outages, or saturated radio frequency (RF) environments. For instance, large gatherings of people with mobile RF transmitters, such as those in stadiums or along crowded event pathways, can create a highly congested RF environment. Further, poor frequency coordination can further degrade communication reliability.

In more severe scenarios, intentional jamming by malicious actors poses a direct threat to the reliability of high-security operations and emergency communication systems. Such malicious activities aim to disrupt or undermine essential communications, thereby jeopardizing the effectiveness and safety of critical operations.

Current Wi-Fi systems face significant challenges in achieving the low-latency and high-reliability requirements necessary for these critical applications. One of the primary bottlenecks in reducing latencies is the duration of channel access procedures that stations (STAs) encounter when attempting to transmit data to an access point (AP). Established channel access procedures, such as the distributed coordination function (DCF), are designed to prevent collisions but inherently result in a minimum time required to obtain channel access. This unavoidable latency can be detrimental to the ultra-low latency or ultra-high reliability operations envisioned for future Wi-Fi revisions.

Existing preemptive solutions to mitigate these issues often come with significant trade-offs. These solutions typically involve suspending or splitting ongoing data transmissions, which introduces additional overhead in terms of implementation complexity. Furthermore, the ongoing data itself may include, but is not limited to, low-latency (LL) traffic with lower priority, complicating the prioritization process. Preemptive solutions can also lead to the extension of transmission opportunities (TXOP), causing the channel to be occupied for longer durations and making it unavailable for other STAs. This extended channel occupancy can further exacerbate power consumption concerns.

It is desired to address the above-mentioned disadvantages or other shortcomings or at least provide a useful alternative.

### SUMMARY

One aspect of the present disclosure provides a serving access point (AP) in a wireless network. The serving AP comprises at least one processor including processing circuitry. The serving AP comprises memory storing instructions that, when executed by the at least one processor individually or collectively, cause the serving AP to receive an interrupt request from the second station while ongoing traffic of the first station in an active data session with the serving AP on a first radio channel or a first link. The second station is associated with a pre-emptive higher priority LL traffic compared to the first station. The instructions that, when executed by the at least one processor individually or collectively, cause the serving AP to determine a second radio channel or a second link for processing the ongoing traffic. The second radio channel or the second link is affiliated with an intra-AP Multi-Link Device (MLD) and offloading via link level redirection (LLR) or affiliated with an inter-AP and offloading via AP level redirection (ALR). The instructions that, when executed by the at least one processor individually or collectively, cause the serving AP to switch the ongoing traffic from the first radio channel or the first link to the second radio channel or the second link, when the second radio channel or the second link is available for processing the ongoing traffic.

In an embodiment, to switch the ongoing traffic, the instructions that, when executed by the at least one processor individually or collectively, cause the serving AP to: determine an availability of data session context at an upper media access control (UMAC) layer of the intra-AP MLD to utilize the second radio channel or the second link to continue the data session; transmit an LLR message to the first station, wherein the LLR message comprises an element for link re-configuration to move the active data session of a traffic Identifier (TID) from the first radio channel or the first link to the second radio channel or the second link after a padding delay; and redirect, the active data session from the first radio channel or the first link to the second radio channel or the second link.

In an embodiment, to switch the ongoing traffic, the instructions that, when executed by the at least one processor individually or collectively, further cause the serving AP to: use the first radio channel or the first link for serving the higher priority LL traffic; and use the second radio channel or the second link for continuing the active data session.

In an embodiment, to switch ongoing traffic, the instructions that, when executed by the at least one processor individually or collectively, cause the serving AP to: detect a neighbor access point (AP) associated with the second radio channel or the second link based on a plurality of parameters, wherein the neighbor AP serves the first station; exchange mutual redirect indications and redirect confirmations between the serving AP and the neighbor AP associated with the second radio channel or the second link; transmit a redirect notify message to the first station to redirect the ongoing traffic to the neighbor AP; serve the higher priority LL traffic of the second station; migrate the first station to the neighbor AP for continued service of its ongoing data session; and simultaneously serve the first station via redirection to the neighbor AP for active data continuity and the second station in parallel without impacting a transmission opportunity (TXOP) of the serving AP.

In an embodiment, the plurality of parameters comprises one or more of a collocation and affiliation to same trusted domain, a power cycle or active state, and a radio channel capability.

In an embodiment, the radio channel capability comprises one or more of a link support information, number of spatial streams, MCS, mechanism(s) of data session context transfer and security key exchange between the APs.

In an embodiment, the data session context between the first station and the serving AP comprises one or more of a sequence number (SN), a packet number (PN) per traffic Identifier (TID), Block Ack (BA) agreement and security key fetching elements.

In an embodiment, to receive the interrupt request, the instructions that, when executed by the at least one processor individually or collectively, cause the serving AP to: determine at least one potential neighbor AP from plurality of neighbor AP based on Quality of Service (QOS) of the first station; transmit a redirect indication message to the at least one neighbor AP to indicate a data session context between the first station and the serving AP, wherein the redirect indication message comprises one or more of a coordination group id, a cause value, and a first station information; receive a redirect confirmation message from the at least one neighbor AP indicating the confirmation of receiving the redirect indication message, wherein the redirect confirmation message comprises one or more of a coordination group id, and a result indicating an accept or reject; and detect the interrupt request indicating incoming pre-emptive low latency traffic from the second station on the first radio channel or the first link while the ongoing traffic of a first station is active on the first radio channel or the first link.

In an embodiment, the at least one processor comprises a pre-emptive low latency traffic (LLT) controller.

One aspect of the present disclosure provides a method of a wireless communication performed by a serving access point (AP). The method comprises receiving, while ongoing traffic of a first station is in an active data session with the serving AP on a first radio channel or a first link, an interrupt request from a second station, wherein the second station is associated with a pre-emptive higher priority LL traffic compared to the first station. The method comprises determining a second radio channel or a second link for processing the ongoing traffic, wherein the second radio channel or the second link is affiliated with an intra-AP multi-link device (MLD) and offloading via the link level redirection (LLR) or affiliated with an inter-AP and offloading via AP level redirection (ALR). The method comprises switching the ongoing traffic from the first radio channel or the first link to the second radio channel or second link, when the second radio channel or the second link is available for processing the ongoing traffic.

In an embodiment, the switching comprises determining an availability of data session context at an upper media access control (UMAC) layer of the intra-AP MLD to utilize the second radio channel or the second link to continue the data session. The switching comprises transmitting an LLR message to the first station, wherein the LLR message comprises an element for link re-configuration to move the active data session of a traffic Identifier (TID) from the first radio channel or the first link to the second radio channel or the second link after a padding delay. The switching comprises redirecting the active data session from the first radio channel or the first link to the second radio channel or the second link.

In an embodiment, the switching comprises detecting a neighbor access point (AP) associated with the second radio channel or the second link based on a plurality of parameters, wherein the neighbor AP serves the first station. The switching comprises exchanging mutual redirect indications and redirect confirmations between the serving AP and the neighbor AP associated with the second radio channel or the second link. The switching comprises transmitting a redirect notify message to the first station to redirect the ongoing traffic to the neighbor AP. The switching comprises serving the higher priority LL traffic of the second station. The switching comprises migrating the first station to the neighbor AP for continued service of its ongoing data session. The switching comprises simultaneously serving the first station via redirection to the neighbor AP for active data continuity and the second station in parallel without impacting a transmission opportunity (TXOP) of the serving AP.

In an embodiment, the plurality of parameters comprises one or more of a collocation and affiliation to same trusted domain, a power cycle or active state, and a radio channel capability.

In an embodiment, the radio channel capability comprises one or more of a link support information, number of spatial streams, MCS, mechanism(s) of data session context transfer and security key exchange between the APs.

In an embodiment, the data session context between the first station and the serving AP comprises one or more of a sequence number (SN), a packet number (PN) per traffic Identifier (TID), Block Ack (BA) agreement and security key fetching elements.

In an embodiment, the receiving comprises determining at least one potential neighbor AP from plurality of neighbor AP based on Quality of Service (QOS) of the first station. The receiving comprises transmitting a redirect indication message to the at least one neighbor AP to indicate a data session context between the first station and the serving AP, wherein the redirect indication message comprises one or more of a coordination group id, a cause value, and a first station information. The receiving comprises receiving a redirect confirmation message from the at least one neighbor AP indicating the confirmation of receiving the redirect indication message, wherein the redirect confirmation message comprises one or more of a coordination group id, and a result indicating an accept or reject. The receiving comprises detecting the interrupt request indicating incoming pre-emptive low latency traffic from the second station on the first radio channel or the first link while the ongoing traffic of a first station is active on the first radio channel or the first link.

One aspect of the present disclosure provides a neighbor access point (AP) in a wireless network. The neighbor AP comprises at least one processor including processing circuitry. The neighbor AP comprises memory storing instructions that, when executed by the at least one processor individually or collectively, cause the neighbor AP to receive a redirection indication message from a serving AP indicating a current data session context between a first station and the serving AP on a first radio channel or a first link. The instructions that, when executed by the at least one processor individually or collectively, cause the neighbor AP to transmit a redirect confirmation message to the serving AP indicating the confirmation of receiving the redirect indication message. The instructions that, when executed by the at least one processor individually or collectively, cause the neighbor AP to receive a redirect request message from the first station to initiate data handover of an ongoing traffic from the serving AP to the neighbor AP, wherein the redirect request message comprises a link reconfiguration request information. The instructions that, when executed by the at least one processor individually or collectively, cause the neighbor AP to transmit a redirect response message to the first station indicating completion of data handover from the serving AP, wherein the redirect response message comprises a link reconfiguration response information. The instructions that, when executed by the at least one processor individually or collectively, cause the neighbor AP to associate with the first station for continuing the ongoing traffic on a second radio channel or a second link affiliated with the neighbor AP.

One aspect of the present disclosure provides a method of a wireless communication performed by a neighbor access point (AP). The method comprises receiving a redirection indication message from a serving AP indicating a current data session context between a first station and the serving AP on a first radio channel or a first link. The method comprises transmitting a redirect confirmation message to the serving AP indicating the confirmation of receiving the redirect indication message. The method comprises receiving a redirect request message from the first station to initiate data handover of an ongoing traffic from the serving AP to the neighbor AP, wherein the redirect request message comprises a link reconfiguration request information. The method comprises transmitting a redirect response message to the first station indicating completion of data handover from the serving AP, wherein the redirect response message comprises a link reconfiguration response information. The method comprises associating with the first station for continuing the ongoing traffic on a second radio channel or a second link affiliated with the neighbor AP.

One aspect of the present disclosure provides a station (STA) in a wireless network. The STA comprises at least one processor including processing circuitry. The STA comprises memory storing instructions that, when executed by the at least one processor individually or collectively, cause the STA to receive a link level redirection (LLR) message from a serving access point (AP), wherein the LLR message comprises an element for link re-configuration to move an active data session of a traffic Identifier (TID) from a first radio channel or a first link to a second radio channel or a second link after a padding delay. The instructions that, when executed by the at least one processor individually or collectively, cause the STA to receive, from the serving AP, a redirect notify message to redirect the ongoing traffic to a neighbor AP.

One aspect of the present disclosure provides a method of a wireless communication performed by a station (STA). The method comprises receiving a link level redirection (LLR) message from a serving access point (AP), wherein the LLR message comprises an element for link re-configuration to move an active data session of a traffic Identifier (TID) from a first radio channel or a first link to a second radio channel or a second link after a padding delay. The method comprises receiving, from the serving AP, a redirect notify message to redirect the ongoing traffic to a neighbor AP.

One aspect of the present disclosure provides a non-transitory computer-readable storage medium. The methods disclosed herein can be performed by one or more computer programs stored on the non-transitory computer-readable storage medium.

In an embodiment, a non-transitory computer-readable storage medium storing one or more computer programs is provided, The one or more computer programs, when executed by at least one processor individually or collectively, cause a serving access point (AP) to receive an interrupt request from the second station while ongoing traffic of the first station in an active data session with the serving AP on a first radio channel or a first link. The second station is associated with a pre-emptive higher priority LL traffic compared to the first station. The computer programs that, when executed by the at least one processor individually or collectively, cause the serving AP to determine a second radio channel or a second link for processing the ongoing traffic. The second radio channel or the second link is affiliated with an intra-AP Multi-Link Device (MLD) and offloading via link level redirection (LLR) or affiliated with an inter-AP and offloading via AP level redirection (ALR). The computer programs that, when executed by the at least one processor individually or collectively, cause the serving AP to switch the ongoing traffic from the first radio channel or the first link to the second radio channel or the second link, when the second radio channel or the second link is available for processing the ongoing traffic.

In an embodiment, a non-transitory computer-readable storage medium storing one or more computer programs is provided, The one or more computer programs, when executed by at least one processor individually or collectively, cause the neighbor access point (AP) to receive a redirection indication message from a serving AP indicating a current data session context between a first station and the serving AP on a first radio channel or a first link. The computer programs that, when executed by the at least one processor individually or collectively, cause the neighbor AP to transmit a redirect confirmation message to the serving AP indicating the confirmation of receiving the redirect indication message. The computer programs that, when executed by the at least one processor individually or collectively, cause the neighbor AP to receive a redirect request message from the first station to initiate data handover of an ongoing traffic from the serving AP to the neighbor AP, wherein the redirect request message comprises a link reconfiguration request information. The computer programs that, when executed by the at least one processor individually or collectively, cause the neighbor AP to transmit a redirect response message to the first station indicating completion of data handover from the serving AP, wherein the redirect response message comprises a link reconfiguration response information. The computer programs that, when executed by the at least one processor individually or collectively, cause the neighbor AP to associate with the first station for continuing the ongoing traffic on a second radio channel or a second link affiliated with the neighbor AP.

In an embodiment, a non-transitory computer-readable storage medium storing one or more computer programs is provided, The one or more computer programs, when executed by at least one processor individually or collectively, cause a station (STA) to receive a link level redirection (LLR) message from a serving access point (AP), wherein the LLR message comprises an element for link re-configuration to move an active data session of a traffic Identifier (TID) from a first radio channel or a first link to a second radio channel or a second link after a padding delay. The computer programs that, when executed by the at least one processor individually or collectively, cause the STA to receive, from the serving AP, a redirect notify message to redirect the ongoing traffic to a neighbor AP.

These and other aspects of the embodiments herein will be better appreciated and understood when considered in conjunction with the following description and the accompanying drawings. It is understood, however, that the following descriptions, while indicating some preferred embodiments and numerous specific details thereof, are given by way of illustration and not of limitation. Many changes and modifications are made within the scope of the embodiments herein without departing from the spirit thereof, and the embodiments herein include all such modifications.

These and other features, aspects, and advantages of the present embodiments are illustrated in the accompanying drawings, throughout which like reference letters indicate corresponding parts in the various figures. The embodiments herein will be better understood from the following description with reference to the drawings.

### BRIEF DESCRIPTION OF FIGURES

FIGS. 1A-1C illustrate mechanisms of preemption for LL traffic according to the related art.

FIG. 2 illustrates TXOP extension due to pre-emption according to the related art.

FIG. 3 is a high-level overview of coordinated multi-APs according to the related art.

FIG. 4 is a block diagram that illustrates the hardware components associated with the serving access point according to the embodiments as disclosed herein.

FIG. 5 is a block diagram that illustrates the hardware components associated with the neighbour access point according to the embodiments as disclosed herein.

FIG. 6 illustrates intra-AP MLD offloading via LLR according to the embodiments as disclosed herein.

FIG. 7 is a sequence diagram that illustrates inter-AP offloading via ALR according to the embodiments as disclosed herein.

FIG. 8 illustrates transition time for redirection according to the embodiments as disclosed herein.

FIG. 9 is a sequence diagram that illustrates signalling to redirect a STA to AP2 according to the embodiments as disclosed herein.

FIG. 10 is a sequence diagram that illustrates further optimizations to redirect a STA to AP2 according to the embodiments as disclosed herein.

FIG. 11 is a sequence diagram that illustrates further optimizations to redirect a STA to AP2 according to the embodiments as disclosed herein.

FIG. 12 illustrates a use case of the proposed method according to the embodiments as disclosed herein.

FIG. 13 is a flow diagram that illustrates the method for handling LL traffic by switching the ongoing traffic from the first radio channel or the first link to the second radio channel or the second link by the serving access point according to the embodiments as disclosed herein.

FIG. 14 is a flow diagram that illustrates the method for handling LL traffic by associating with the first station for continuing the ongoing traffic on a second radio channel or the second link affiliated with the neighbour access point according to the embodiments as disclosed herein.

### DETAILED DESCRIPTION

The embodiments herein and the various features and advantageous details thereof are explained more fully with reference to the non-limiting embodiments that are illustrated in the accompanying drawings and details in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples are not to be construed as limiting the scope of the embodiments herein.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements.

It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. The phrase “one or more of,” when used with a list of items, means that different combinations of one or more of the listed items may be used, and only one item in the list may be needed. For example, “one or more of: A, B, of C” includes any of the following combinations: A, B, C, A and B, A and C, B and C, and A and B and C. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it denotes that the element may be coupled with the other element directly (e.g., wiredly), wirelessly, or via a third element.

As is traditional in the field, embodiments are described and illustrated in terms of blocks that carry out a described function or functions. These blocks, which referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and optionally be driven by firmware and software. The circuits, for example, be embodied in one or more semiconductor chips, or on substrate supports such as printed circuit boards and the like. The circuits constituting a block are implemented by dedicated hardware, or by a processor (e.g., one or more programmed microprocessors and associated circuitry), or by a combination of dedicated hardware to perform some functions of the block and a processor to perform other functions of the block. Each block of the embodiments is physically separated into two or more interacting and discrete blocks without departing from the scope of the proposed method. Likewise, the blocks of the embodiments are physically combined into more complex blocks without departing from the scope of the proposed method.

The accompanying drawings are used to help easily understand various technical features and it is understood that the embodiments presented herein are not limited by the accompanying drawings. As such, the proposed method is construed to extend to any alterations, equivalents and substitutes in addition to those which are particularly set out in the accompanying drawings. Although the terms first, second, etc. used herein to describe various elements, these elements are not to be limited by these terms. These terms are generally used to distinguish one element from another.

Next generation extremely high throughput (EHT) Wi-Fi systems support multiple bands of operation, called links, over which an Access Point (AP) and a non-AP device can communicate with each other. Both the AP and non-AP device may be capable of communicating on different bands/links, which is referred to as multi-link operation (MLO). Wi-Fi devices that support MLO are referred to as multi-link devices (MLDs). With MLO, it is possible for a non-access point (non-AP) MLD to discover, authenticate, associate, and set up multiple links with an AP MLD. Channel access and frame exchange are possible on each link that is set up between the AP MLD and non-AP MLD. The component of an MLD responsible for transmission and reception on one link is referred to as a station (STA). With bandwidth aggregation across multiple channels/bands, MLO offers significant gains in throughput and latency performance compared to single link operation in the previous generation.

The meaning of low latency differs depending on the specific application, established industry norms, and the expectations of users. Low latency traffic is derived from the latency requirements of modern-day applications (e.g., remote medical assistance, VR, XR) that generate data in real time at a very high rate. To ensure a seamless and optimal user experience, this data must be delivered within a few milliseconds with minimal retransmissions, i.e., minimal delay in transmitting data over a network. Examples of low latency for different applications include in-app notifications appearing in less than 1 second, audio and video streaming requiring initiation within 1-5 seconds, real-time communication ensuring responses within 150 milliseconds or less, online gaming providing smooth performance with 100 milliseconds or less latency, Augmented Reality (AR) and Virtual Reality (VR) with 20 milliseconds or less latency, and high-frequency trading with 1-20 microseconds of latency. Hence, latency reduction in core wireless technology is a primary requirement to be improved in the next generation Wi-Fi8, i.e., Ultra High Reliability (UHR) group.

One of the goals of UHR is to improve latency for latency-sensitive or low latency (LL) traffic. The LL traffic can be periodic or aperiodic in nature. Periodic LL traffic can be handled by techniques such as Multi-AP coordination or enhanced medium access methods. However, aperiodic LL traffic requires more advanced solutions, such as preemption techniques for handling LL traffic. Generally, a preemption technique involves the following basic steps: while an ongoing data transmission is on a channel, a station indicates the need to transmit LL traffic on the same channel, suspends or splits the ongoing data flow, allows the station to transmit LL traffic, and upon LL traffic completion, resumes or transmits the remaining split parts of the original data traffic.

The introduction of priority among LL traffic itself and its consideration for differentiation during preemption is being discussed in the WiFi8 working group to address ambiguity in LL traffic-based preemption cases. Based on the Transmission Opportunity (TXOP) holder and TXOP responder of the channel, multiple cases need to be handled for a preemption solution. These include downlink (DL) LL traffic arriving during a DL TXOP (i.e., during DL transmission by AP) and uplink (UL) LL traffic arriving during a DL TXOP (i.e., during DL transmission by the AP). Further, downlink (DL) LL traffic arriving during the UL TXOP (i.e., during UL transmission by client/station (STA)) and others.

Existing methods include a procedure of preemption for low latency traffic. An UHR AP that supports preemption indicates the same (i.e., preemption is enabled) by including information in DL Physical Protocol Data Unit (PPDU) via an “initial control frame” and providing ample inter-frame spacing called xIFS for a client to indicate if it has any low latency traffic. The AP then allows the LL traffic to be transmitted by “suspending the ongoing data.” Another method describes the concept of preemption of PPDUs, i.e., truncating a PPDU carrying non-latency sensitive traffic to serve STAs with latency constraints. This method includes monitoring the channel for ongoing data unit transmissions, deriving the truncation condition, data reception duration, granularity of truncation, and truncation flag inside the preamble of the data unit. Based on the suggested intelligence, the ongoing data unit transmission is preempted by low latency traffic. Another the related art suggests a signaling-based idea wherein when a client station is transmitting uplink data to the AP, and the AP itself has some low latency data to transmit on the same channel, the AP includes an indication for the same within the Block Acknowledgement message sent to the client STA in response to the uplink packet sent by the STA. Upon receiving this indication via Block Ack packet in DL, the STA will suspend its own data transmission to allow the AP to send its low latency data packet.

The preemptive low latency traffic leads to problems such as implementation overhead, poor key performance indicators (KPIs), extension of TXOP causing channel unavailability to other users, and extension of TXOP causing an impact on power consumption of the serving AP. Further, the TXOP preemption procedures have been developed to work around channel access procedures to reduce latency by allowing STAs to preempt an AP's TXOP for low latency traffic transmissions. However, these preemption procedures may introduce new issues, such as collisions between transmissions from devices attempting to preempt the TXOP, thus wasting channel resources, the AP losing its TXOP entirely and having its own throughput degraded, and increased power consumption from STAs unsuccessfully attempting to preempt the TXOP.

A novel method to handle the preemptive solution for LL traffic in alternate ways rather than just suspending/splitting ongoing data is described in the embodiments. The generic elements of M-AP coordination and roaming solutions are enhanced with the overall aim to minimize the latency of service of all traffic, meet the quality of service (QOS), adhere to the power cycle, and optimize channel utilization. The embodiments disclosed herein provide a system and a method for handling preemptive LL traffic in UHR. The present disclosure proposes an intra-AL MLD offloading mechanism via link-level redirection upon the event of preemptive LL traffic on a channel and an inter-AP offloading via AP-level redirection upon the event of preemptive LL traffic on a channel. Further, the method proposes an overall messaging flow to realize AP-level redirection, a scheme to identify suitable candidate AP(s) for redirection, and an enhanced context exchange with candidate AP for redirection. The proposed method introduces a transition time window concept to realize AP-level redirection efficiently and a detailed signaling mechanism for inter-AP level redirection of STA. Further, the proposed method suggests optimizations to the proposed signaling mechanism and the message formats for newly proposed messages within the redirection sequence.

The embodiments of the present disclosure provide procedures and devices designed to enable channel access for STAs during TXOP preemption processes. The described methods ensure coordination between multiple STAs and the associated AP, allowing TXOP preemption to be executed efficiently without causing unnecessary channel resource wastage, reducing throughput, or increasing the power consumption of other STAs or the AP.

While the present disclosure caters to handling a later stage of preemption to support its own UHR requirements and timely delivery of preempted data via an alternate method rather than suspension/splitting of preempted data, upon reception of this indication, the STA shall suspend its ongoing data transmission to allow the AP to transmit low latency data packets. The present disclosure provides an alternate method to handle the data transmission of the STA rather than suspending it, ensuring that UHR KPIs of the data being preempted can also be met and not just suspended/split for the sake of low latency data handling.

In an embodiment, the serving access point can also be referred to as a serving AP or AP 1, and the neighbor access point can be referred to as neighbor AP or AP 2. Similarly, the term first station can be referred to as STA 1, and the second station can be referred to as STA 2.

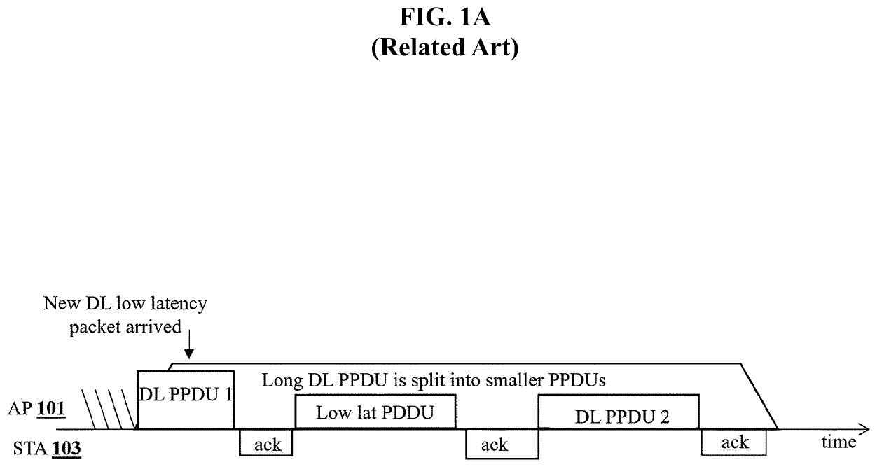

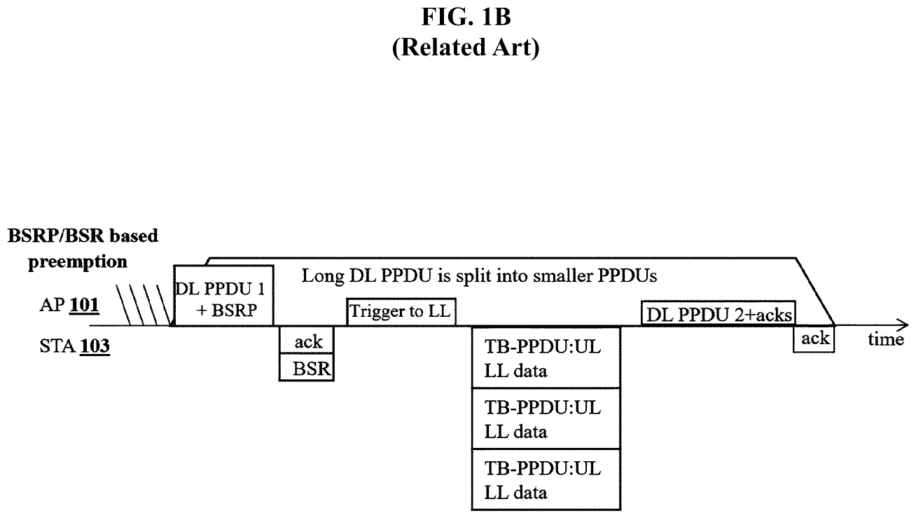

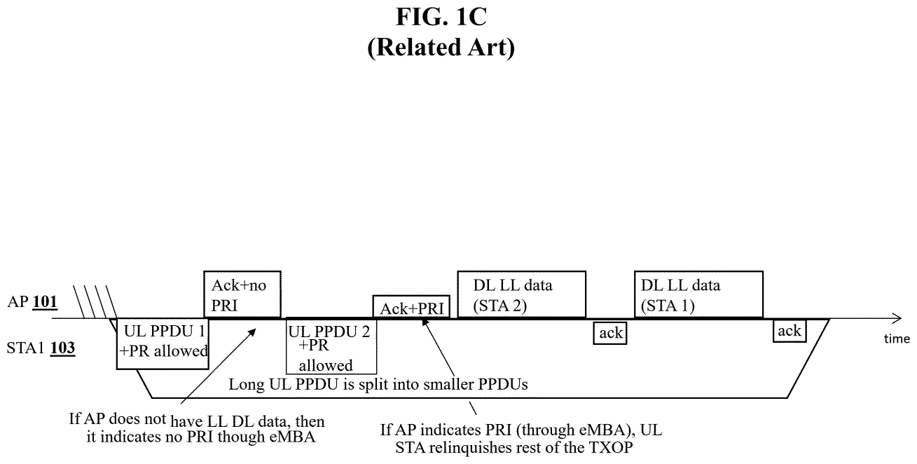

Referring now to the drawings and more particularly to FIGS. 1 through 14, where similar reference characters denote corresponding features consistently throughout the figure, these are shown preferred embodiments.

FIGS. 1A-1C illustrate mechanisms of preemption for LL traffic according to the related art. These figures provide examples of preemption where LL traffic is managed through baseline mechanisms, which include either suspending ongoing data or splitting ongoing data.

Referring to FIG. 1A, when the AP 101 is a Downlink (DL) Transmission Opportunity (TXOP) holder for an ongoing data transmission, an interrupting DL LL traffic can be served by suspending or splitting the ongoing data's Physical Protocol Data Units (PPDUs). The DL LL traffic is first transmitted on the channel, followed by the resumption or transmission of the split parts of the original data PPDU.

In FIG. 1B, when the AP 101 is a DL TXOP holder for an ongoing data transmission, it can include, but is not limited to, a Poll bit in the DL PPDU. The STA 103 having UL LL traffic can include, but is not limited to, the indication in the corresponding Poll Response, such as in a Buffer Status Report (BSR). Upon seeing the indication, the AP 101 can suspend or split the ongoing data PPDU and send a Trigger Signal to the STA 103 for it to use the channel for UL LL traffic. Once the UL LL traffic is served, the original data can be resumed by transmitting the split parts of the DL traffic.

FIG. 1C illustrates a scenario where the STA 103 is a UL TXOP holder for an ongoing data transmission. The STA can include, but is not limited to, a Preemption allowed (PR) bit in the UL PPDU, and the AP having DL LL traffic can include, but is not limited to, the Preemption Indication (PRI) in the next DL Ack message (for the previous UL PPDU). Upon seeing the PRI, the STA can suspend or split the ongoing data PPDU and allow the AP to use the channel for DL LL traffic. Once the DL LL traffic is served, the original data may be resumed by transmitting the split parts of the UL traffic.

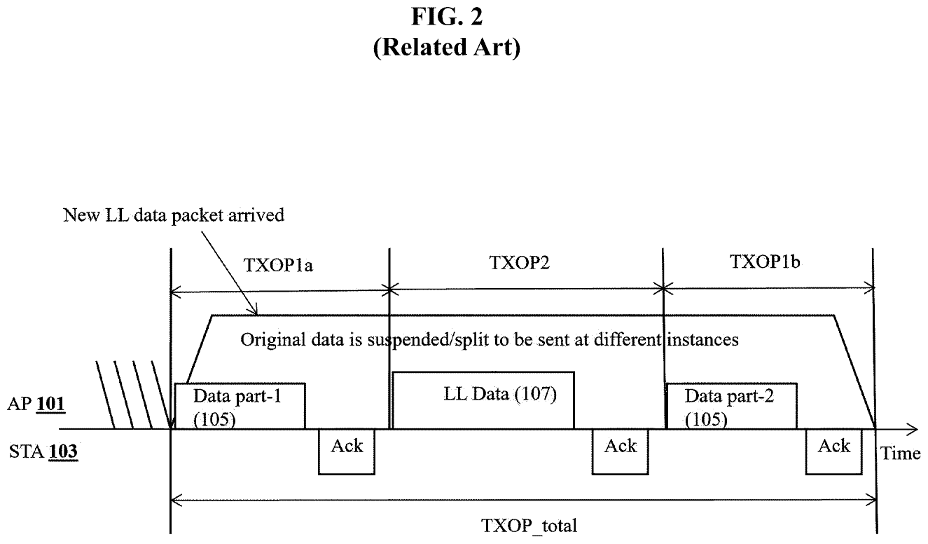

FIG. 2 illustrates TXOP extension due to pre-emption according to the related art. Pre-emptive solutions are the most preferred methods for handling LL traffic in current Wi-Fi standard contributions due to their ability to provide the required channel resources immediately for high priority low latency traffic. However, these solutions always come at a cost of suspending or splitting the current ongoing data transmissions. The suspension or splitting of the ongoing data leads to problems such as overhead in terms of implementation aspects to handle ongoing data suspend/resume and splitting/merging. The ongoing data itself could have some form of LL traffic1 (e.g., video conferencing) with a bit lower priority than the pre-emptive LL traffic2 (e.g., remote medical assistance). Therefore, straightforwardly interrupting traffic1 and giving away the channel to traffic2 is not always a logical solution, as the user with LL traffic1 will be negatively impacted in terms of latency and service.

Further, the method of suspending or splitting the ongoing traffic leads to the extension of TXOP, causing the channel to be occupied for a longer duration, thus making it unavailable for other STAs. Another significant impact is on the AP's power consumption, as it has to remain awake for a longer duration, especially if the AP had planned a low power mode/doze/sleep during this duration.

Referring to FIG. 2, the original Data part-1 is being transmitted at time TXOP1a. In between, a new Low Latency (LL) data packet arrives, causing the ongoing Data part-1 to be suspended or split to be sent at different instances, i.e., after the successful transmission of the new LL data packet. The transmission of the new LL data packet takes place for the time interval of TXOP2 units, after which the remaining data packets of Data part-1 are transmitted for the time interval of TXOP1b units. When there is no LL traffic, the original intended channel occupation time is less than or equal to (TXOP1a+TXOP1b) or TXOP1. When there is LL traffic, the channel occupation time by LL traffic only is TXOP2, and due to LL traffic, the total channel occupation time is (TXOP1+TXOP2) or TXOP_total, which is greater than TXOP1.

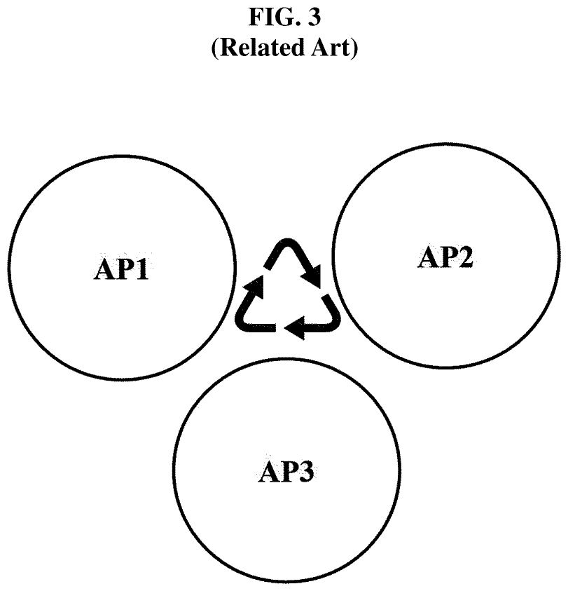

FIG. 3 provides a high-level overview of coordinated multi-Access Points (APs) according to the related art. Architecture enhancements for Ultra High Reliability (UHR) in WiFi8 standards are being extensively investigated. The concept of multi-Access Point communications involves an AP discovering surrounding APs, engaging in to-and-fro information exchange, and entering into negotiations. This process forms a group of coordinated APs to minimize co-channel interference and maximize optimal channel usage while meeting UHR Key Performance Indicators (KPIs). Various types of coordination schemes under consideration include Coordinated Access Points (C-AP), Coordinated Time Division Multiple Access (C-TDMA), Coordinated (Restricted) Target Wakeup Time (C-(R)TWT), Coordinated Beam Forming (C-BF), Coordinated Spatial Reuse (C-SR), and Coordinated Joint Transmissions (C-JT) for both coherent and non-coherent transmissions, among others.

A more specific case involves dedicated coordination between a serving AP and potential target APs, where all APs are affiliated within the same mobility domain in a roaming scenario. The aim is to perform a near lossless handover of a client between two non-collocated APs with minimal latency. The most commonly agreed-upon architecture for WiFi8 standards includes enhanced context transfer either via some form of Common Control Entity between APs or over-the-DS, reduction of the involved signaling steps, pre-authentication, pre-configuration and signaling-in-advance (with possibly more than one potential roaming candidate AP) to facilitate faster client association changes during roaming scenarios.

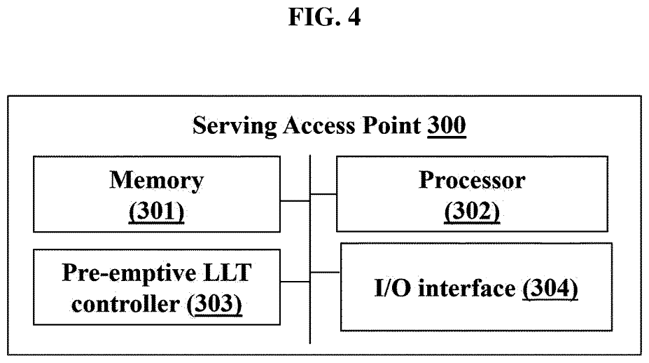

FIG. 4 is a block diagram that illustrates the hardware features of the serving AP 300 according to the embodiments as disclosed herein.

Examples of the first station and the second station can include, but are not limited to, Consumer Electronics (such as Mobile Phones and Smartphones), Tablets, Wearable Devices, Computing Devices (such as Laptops, Notebooks, Desktops, Workstations, etc.), IoT Devices, Automotive Systems (such as connected cars, Autonomous Vehicles, Vehicle-to-Everything (V2X) communication devices, etc.), Enterprise Devices such as robotics, Specialized Equipment (such as Medical Devices, Public Safety Devices, etc.), Media Devices (such as Gaming Consoles, Streaming Devices, etc.). Further the first user equipment (UE) 105 and the second UE 106 can belong to same user or the different user.

Examples of the wireless communication network system include, but are not limited to, Wireless Local Area Network (WLAN) including both enterprise and residential scenarios that uses Listen-Before-Talk (LBT) and Enhanced Distributed Channel Access (EDCA) procedures for channel acquisition.

The serving AP 300 can encompass a diverse range of devices including but not limited to APs, wireless routers, range extenders and repeaters, among others. In an embodiment, the serving AP 300 includes a memory 301, a processor 302, an I/O interface 303, and a Pre-emptive LLT controller 304.

The memory 301 stores instructions to be executed by the processor 302. The memory 301 stores instructions that, when executed by at least one processor individually or collectively, cause the serving AP 300 to perform the methods and/or the operations described herein. The at least one processor may include the combination of one or more processors such as the processor 302, a pre-emptive low latency traffic (LLT) controller 303, a CPU, GPU, MPU, an application processor (AP), and a communication processor (CP). The memory 301 can include non-volatile storage elements. Examples of such non-volatile storage elements may include, but are not limited to, magnetic hard disks, optical disks, floppy disks, flash memories, or forms of electrically programmable memories (EPROM) or electrically erasable and programmable (EEPROM) memories. In addition, the memory 301 may in some examples be considered a non-transitory storage medium. The term non-transitory may indicate that the storage medium is not embodied in a carrier wave or a propagated signal. However, the term non-transitory should not be interpreted that the memory 301 is non-movable. In some examples, the memory 301 stores larger amounts of information. In certain examples, a non-transitory storage medium may store data that can over time change (e.g., in Random Access Memory (RAM) or cache). The memory 301 stores the supported links, supported bandwidth, supported number of spatial streams and the supported MSCs and others. Further, it stores capabilities of the UE 200 and the information regarding the power saving information.

The processor 302 may include one or a plurality of processors. The one or the plurality of processors may be a general-purpose processor such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor 302 may include multiple cores and is configured to execute the instructions stored in the memory 301. The processor 302 fetches the supported links, supported bandwidth, supported number of spatial streams and the supported MSCs information of the neighbor access point 400, information regarding the KPIs, and the occurrence of pre-emptive LL traffic at the serving access point. Further, the processor 302 retrieves instructions and executes them. The processor 302 may include at least one processor including processing circuitry. The at least one processor may include the combination of one or more processors such as a CPU, GPU, MPU, an application processor (AP), and a communication processor (CP).

The input-output (I/O) interface 304 transmits the information between the memory 301 and external peripheral devices. The peripheral devices are the input-output devices associated with the serving AP 300. The I/O interface 304 receives several pieces of information from a plurality of UEs, network devices, servers, and the like. The I/O interface 304 ensures that the operating speed of the processor is synchronized with respect to the input and output devices. The I/O interface 304 establishes a connection between different peripheral devices like radio channels, links, memory, and others to perform handling LL traffic in a wireless network.

In an embodiment, the pre-emptive LLT controller 303 of the AP1 300 communicates with the processor 302, I/O interface 304, and memory 301 to handle low latency (LL) traffic in a wireless network. The pre-emptive LLT controller 303 receives an interrupt request from the second station 600 at the serving access point 300 during ongoing traffic of the first station 500 in an active data session with the serving access point 300 on a first radio channel or the first link. The second station 600 is associated with pre-emptive higher priority LL traffic compared to the first station 500. Upon receiving the interrupt request, the pre-emptive LLT controller 303 determines the second radio channel or the second link for handling the ongoing traffic. This second radio channel or second link is affiliated with an intra-AP MLD and offloading via the LLR or affiliated with an inter-AP and offloading via the ALR. Further, the pre-emptive LLT controller 303 switches the ongoing traffic from the first radio channel or the first link to the second radio channel or the second link when the second radio channel or the second link becomes available for handling the ongoing traffic. The pre-emptive LLT controller 303 may include at least one processor including processing circuitry. The pre-emptive LLT controller 403 may include the combination of one or more processors such as a CPU, GPU, MPU, an application processor (AP), and a communication processor (CP).

In an embodiment, the pre-emptive LLT controller 303 determines the availability of data session context at an upper media access control (UMAC) layer of the intra-AP MLD to utilize the second radio channel or the second link to continue the data session. Further, the pre-emptive LLT controller 303 sends the LLR message to the first station 500. The LLR message includes an element for link re-configuration to move the active data session of a traffic identifier (TID) from the first radio channel or the first link to the second radio channel or the second link after a padding delay. The pre-emptive LLT controller 303 then redirects the active data session from the first radio channel or the first link to the second radio channel or the second link. The first radio channel or the first link is used for serving the higher priority LL traffic, whereas the second radio channel or the second link is used for continuing the active data session.

The pre-emptive LLT controller 303 detects the neighbor access point 400 associated with the second radio channel or the second link based on a plurality of parameters. The neighbor access point 400 agrees to serve the first station 500. Mutual redirect indications and redirect confirmations are exchanged by the pre-emptive LLT controller 303 between the serving access point 300 and the neighbor access point 400 associated with the second radio channel or the second link. Further, the pre-emptive LLT controller 303 sends a redirect notify message to the first station 500 to redirect it to the neighbor access point 400. Higher priority LL traffic of the second station 600 is served by the pre-emptive LLT controller 303, which also migrates the first station 500 to the neighbor access point 400 for continued service of its ongoing data session. Simultaneously, the pre-emptive LLT controller 303 serves the first station 500 via redirection to the neighbor access point 400 for active data continuity and the second station 600 in parallel, without impacting the transmission opportunity (TXOP) of the serving access point 300.

In an embodiment, the plurality of parameters includes the collocation and affiliation to the same trusted domain, a power cycle or active state, and a radio channel capability. The radio channel capability comprises one or more of the following: link support information, number of spatial streams, MCS mechanisms, data session context transfer, and security key exchange between the APs. The data session context between the first station 500 and the serving access point 300 comprises one or more of the following: a sequence number (SN), a packet number (PN) per TID, Block Ack (BA) agreement, and security key fetching elements.

In another embodiment, the pre-emptive LLT controller 303 determines the potential neighbor access point 400 from a plurality of neighbor access points 400 based on the Quality of Service (QOS) of the first station 500. Further, the pre-emptive LLT controller 303 transmits a redirect indication message to at least one neighbor access point 400 to indicate a data session context between the first station 500 and the serving access point 300. The redirect indication message comprises one or more of the following: a coordination group ID, a cause value, and first station 500 information. Upon receiving the redirect confirmation message from the neighbor access point 400, the pre-emptive LLT controller 303 confirms the receipt of the redirect indication message. The redirect confirmation message includes the coordination group ID and a result indicating acceptance or rejection. Furthermore, the pre-emptive LLT controller 303 detects an interrupt request indicating incoming pre-emptive low latency traffic from the second station 600 on the first radio channel or the first link, while the ongoing traffic of the first station 500 remains active on the first radio channel or the first link.

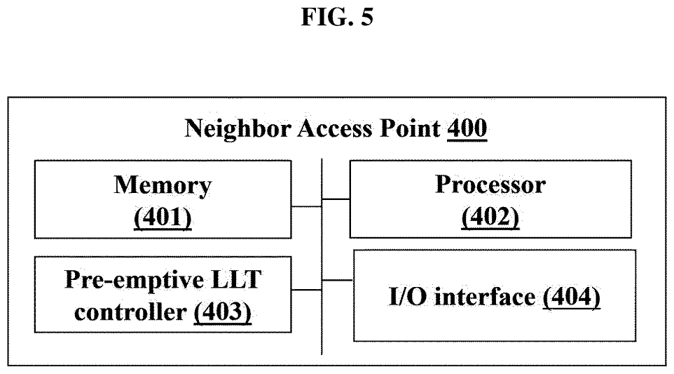

FIG. 5 is a block diagram that illustrates the hardware features of the neighbor AP 400 according to the embodiments as disclosed herein. The neighbor AP 400 can encompass a diverse range of devices including but not limited to APs, routers among others. In an embodiment, the neighbor AP 400 includes a memory 401, a processor 402, an I/O interface 404, and a Pre-emptive LLT controller 403.

The memory 401 stores instructions to be executed by the processor 402. The memory 401 stores instructions that, when executed by at least one processor individually or collectively, cause the neighbor AP 400 to perform the methods and/or the operations described herein. The at least one processor may include the combination of one or more processors such as the processor 402, a pre-emptive low latency traffic (LLT) controller 403, a CPU, GPU, MPU, an application processor (AP), and a communication processor (CP). The memory 401 can include non-volatile storage elements. Examples of such non-volatile storage elements may include magnetic hard disks, optical disks, floppy disks, flash memories, or forms of electrically programmable memories (EPROM) or electrically erasable and programmable (EEPROM) memories. In addition, the memory 401 may in some examples be considered a non-transitory storage medium. The term non-transitory may indicate that the storage medium is not embodied in a carrier wave or a propagated signal. However, the term non-transitory should not be interpreted that the memory 401 is non-movable. In some examples, the memory 401 stores larger amounts of information. In certain examples, a non-transitory storage medium may store data that can over time change (e.g., in Random Access Memory (RAM) or cache). The memory 301 stores the supported links, supported bandwidth, supported number of spatial streams and the supported MSCs and others. Further, it stores capabilities of the UE 200 and the information regarding the power saving information.

The processor 402 may include one or more processors. The one or more processors may be, for example, a general-purpose processor such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor 402 may include multiple cores and is configured to execute the instructions stored in the memory 401. The processor 402 fetches the capabilities of the station 500, requirements as shared by the serving access point 300, the supported links, supported bandwidth, supported number of spatial streams and the supported MSCs information. Further, the processor 402 retrieves instructions and executes them.

The I/O interface 404 transmits the information between the memory 401 and external peripheral devices. The peripheral devices are the input-output devices associated with the neighbor AP 400. The I/O interface 404 receives several pieces of information from a plurality of UEs, network devices, servers, and the like. The I/O interface 404 ensures that the operating speed of the processor is synchronized with respect to the input and output devices. The I/O interface 404 establishes a connection between different peripheral devices like radio channels, links, memory, and others to perform handling LL traffic in a wireless network. The processor 402 may include at least one processor including processing circuitry. The at least one processor may include the combination of one or more processors such as a CPU, GPU, MPU, an application processor (AP), and a communication processor (CP).

In an embodiment, the pre-emptive LLT controller 403 of the neighbor Access Point 400 communicates with the processor 402, I/O interface 404, and memory 401 for handling low latency (LL) traffic in a wireless network. The pre-emptive LLT controller 403 receives the redirection indication message from the serving access point 300 indicating the current data session context between a first station 500 and the serving access point 300. The pre-emptive LLT controller 403 transmits the redirect confirmation message to the serving access point 300 indicating the confirmation of receiving the redirect indication message and receives the redirect request message from the first station 500 to initiate data handover of an ongoing traffic from the serving access point 300 to the neighbor access point 400. The redirect request message includes a link reconfiguration request information. The pre-emptive LLT controller 403 transmits the redirect response message to the first station 500 indicating completion of data handover from the serving access point 300. The redirect response message comprises a link reconfiguration response information. The pre-emptive LLT controller 403 associates with the first station 500 for continuing the ongoing traffic on a second radio channel or the second link affiliated with the neighbor access point 400. The pre-emptive LLT controller 403 may include at least one processor including processing circuitry. The pre-emptive LLT controller 403 may include the combination of one or more processors such as a CPU, GPU, MPU, an application processor (AP), and a communication processor (CP).

While FIGS. 4 and 5 illustrate the hardware components of the serving access point 300 and the neighbor access point 400 respectively, alternative embodiments may include different or additional components. The labels or names of these elements are illustrative and do not limit the invention's scope. Components may also be combined to perform similar functions.

To solve the problems associated with the pre-emptive techniques, the proposed embodiments describe an intra-AP MLD offloading via the LLR method and an inter-AP MLD offloading via the ALR method. The proposed intra-AP MLD offloading and the inter-AP MLD offloading hold certain advantages over the conventional splitting or suspend method. The advantages include implementation simplicity by the implementation of the offloading mechanism with minimal framework overhead. Further, the offloading techniques leverage multi-AP coordination and roaming solution framework concepts, maintain UHR KPI for lower priority pre-empted traffic in the presence of high priority low latency traffic as well. Further, the offloading results in avoiding extension of TXOP over a channel, thus clearing the channel within time for other users and helps reduce the power consumption of the serving AP. Furthermore, it helps to maintain the expected power cycle of the serving AP.

The proposed solution is based on the premise that a serving AP is aware of its trusted neighbor APs via information exchanged between them (for example, either via some interface or over the Distribution System (DS) backhaul) under several multi-AP coordination schemes and roaming solutions. The known set of information may include, but is not limited to, collocation and affiliation to the same trusted domain, power cycle/active state (as per one of our other proposals for multi-AP coordination for power saving), radio/PHY capabilities including link support information, number of spatial streams, MCS mechanism(s) of data session context transfer, and security key exchange between the APs and others. Equipped with the above knowledge, when an AP1 (which is serving an ongoing data transmission to STA1 over a channel1/link1) is interrupted by another STA2 for pre-emption of the channel to serve STA2's LL traffic, then in order to avoid any of the highlighted problem scenarios, AP1 can make the following informed decision to handle the ongoing traffic and LL traffic.

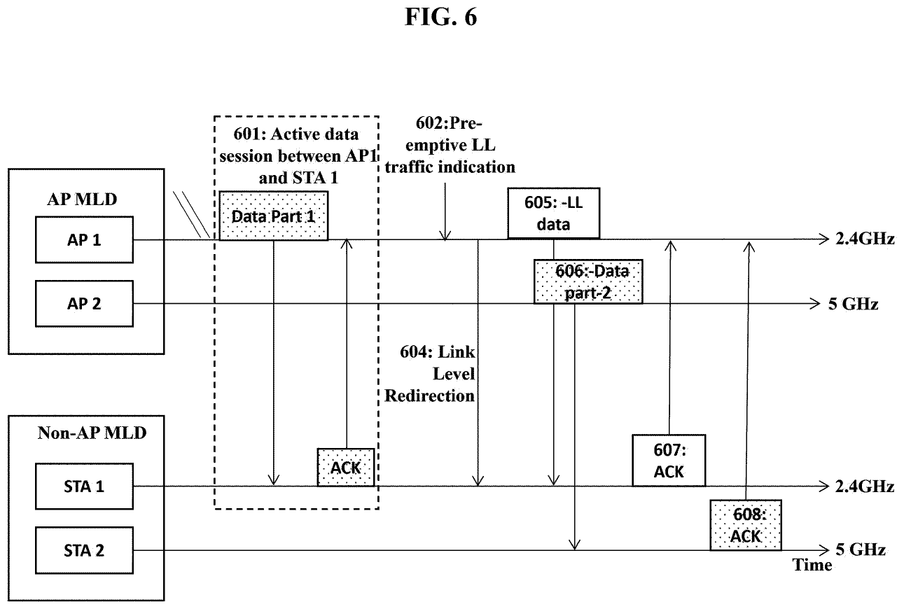

FIG. 6 illustrates intra-AP MLD offloading via LLR according to the embodiments as disclosed herein. The figure illustrates a scenario of handling a pre-emptive LL traffic event by leveraging the presence of additional radio(s) in the AP MLD and non-AP MLD devices. At 601, the non-AP MLD's STA 1 500 is in an active data session with the AP MLD's AP 1 300 at a 2.4 GHz channel. At 602, a pre-emptive LL traffic indication is received at AP 1 300. Since all the data session context is readily available at UMAC of AP MLD, it quickly checks and decides to use the other available channel/link at 5 GHz to serve the ongoing data session instead of suspending/splitting it.

At 604, the AP 1 300 sends an LLR message to STA 1 500, which essentially includes an element for link re-configuration to move the ongoing data session for a TID from the 2.4 GHz to the 5 GHz link after a padding delay. The TID is a label used in Wi-Fi networks to classify data packets according to the type of service they require. TID helps in prioritizing traffic by identifying the nature of the data being transmitted, such as voice, video, best effort, or background. This classification allows the network to apply the appropriate QoS policies to ensure that high-priority traffic like voice and video is delivered promptly and efficiently. The padding delay or the buffer time assists the receiving non-AP MLD in accurately determining the start of a transmission, compensating for propagation delays, mitigating interference caused by timing discrepancies, and maintaining stable communication over time.

At 606, the new 5 GHz channel is being used for serving the previous ongoing data session itself as the current 2.4 GHz channel is being used for serving LL traffic at 605. At 607 and 608, AP1 receives an acknowledgement from STA1 and/or STA2.

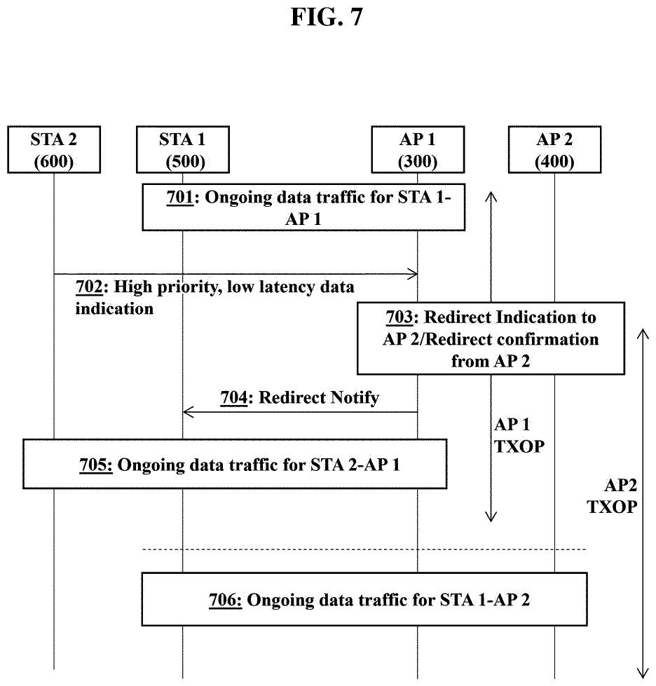

FIG. 7 is a sequence diagram that illustrates inter-AP offloading via ALR according to the embodiments as disclosed herein.

At 701, the STA 1 500 is in an active data session with serving AP 1 300. At 702, the AP 1 300 is being interrupted for pre-emption by STA 2 400 with LL traffic. At 703, the AP 1 300 identifies a neighbor AP 2 400 suitable for offloading the ongoing data session of the STA 1-AP 1, followed by mutual Redirect Indication and Redirect Confirmation from AP 2 agreeing to serve STA 1.

At 704, the AP 1 300 notifies STA 1 500 to redirect to target AP 2 400 via Redirect Notify message. At 705, the AP 1 300 is serving the LL traffic of STA 2 600.

At 706, the STA 1 500 has migrated to AP 2 400 for getting served for its ongoing data session.

Further, both the STAs get served in parallel without impacting the TXOP of serving AP 1 300. The proposed mechanisms are applicable to both stationary and mobility scenarios. If STA 1 500 is already LL traffic and interrupting STA 2 600 is 2nd lower priority LL traffic, then AP 1 300 can choose to continue serving STA 1 500 and instead redirect STA 2 600 itself to AP 2 400.

Identification of the candidate(s) neighbor AP 2 400 by the serving AP 1 300 is one of the most important aspects of this solution. As part of the various proposed (in standards) multi-AP coordination schemes, there is a large set of information exchanged and negotiated between participating APs (e.g., AP 1 and AP 2), which essentially makes AP 1 300 aware of the operating characteristics of a neighbor AP 2 400, including but not limited to supported links, supported bandwidth, supported number of spatial streams, supported MCS, etc.

In an embodiment, the multi-APs coordinating for Power Saving, AP1 is also aware of AP2's power saving scheme, power saving duration, radio/physical layer capabilities applied during different power saving cycles, etc.

Equipped with the above information, AP1 300 can decide which candidate(s) AP2 400 is suitable to serve an offloaded STA from AP1 300 if agreed, meeting the offloaded STA's traffic throughput, latency, QoS requirements, etc.

After identifying the potential candidate AP2 400, AP1 300 needs to share the current data session context with AP2 in order to quickly establish the STA's context at AP2 400.

Borrowing some of the elements from the roaming framework, AP1 300 shall share the below information with AP2 400 as part of the data session context, but not limited to: sequence number (SN), packet number (PN) per TID, BA agreement if any, security key fetching elements/exchange, etc.

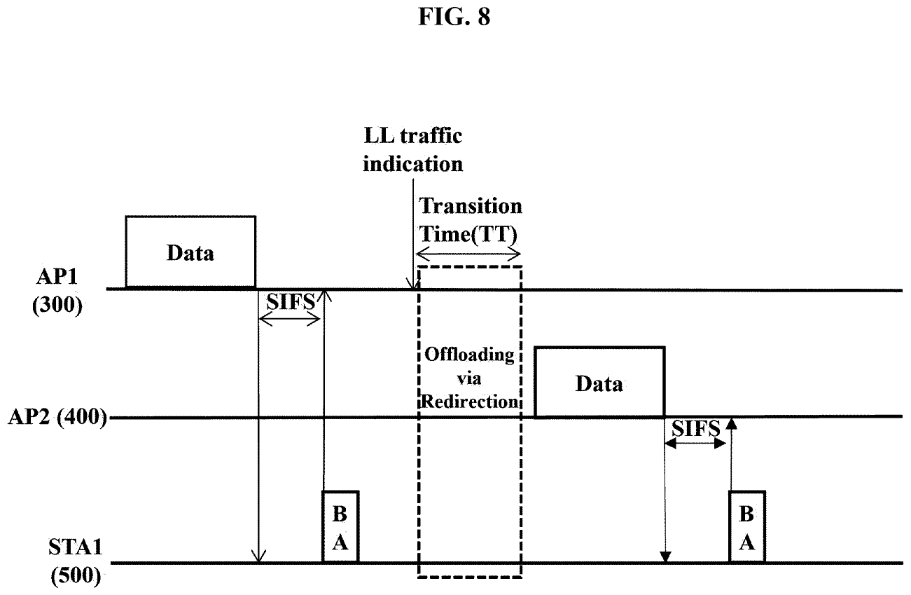

FIG. 8 illustrates the transition time for redirection according to the embodiments disclosed herein. Transition Time (TT) is defined as the shortest time duration within which a serving AP1 shall process the complete redirection procedure. It is important to complete the entire redirection procedure-related signalling within this duration to ensure that STA1, which is being offloaded to neighbour AP2, is able to quickly get re-associated and resume its data flow to minimize data flow interruption.

TT shall start upon receiving a pre-emptive LL traffic indication at AP1. By the end of TT, STA1 should have re-associated with AP2 successfully with the data session context established. Practically, the value of TT should be less than or equal to an optimal UHR roaming scenario time duration; e.g., many companies are targeting <=1 ms for roaming to complete. Hence, standard implementation shall target to minimize it as much as possible.

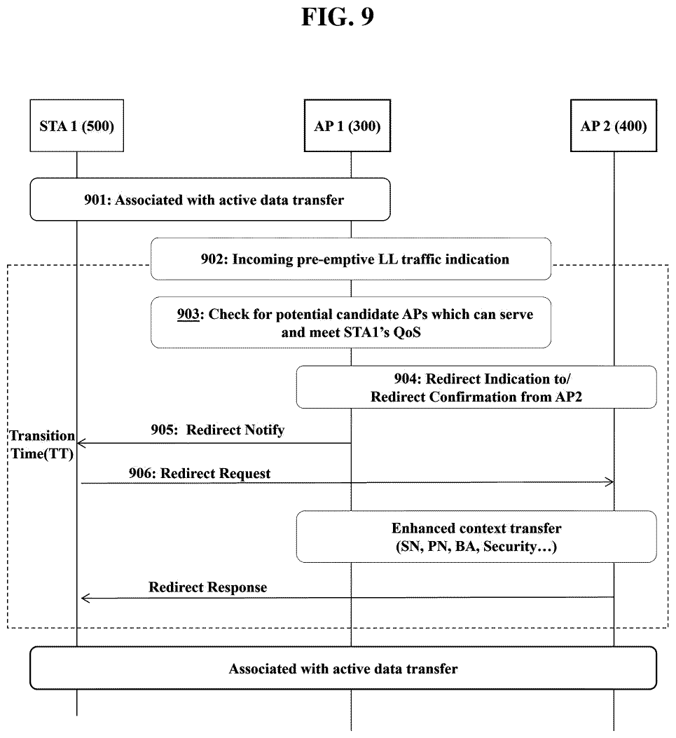

FIG. 9 is a sequence diagram that illustrates signaling to redirect a STA to AP2 according to the embodiments as disclosed herein. The entire sequence of FIG. 9 occurs within the Transition Time wherein the STA 1 500 is associated with AP 1 300 and is in active data transmission as illustrated at 901.

At 902, an event is triggered when the AP 1 300 receives a pre-emptive LL traffic indication. The AP 1 300 finds potential AP 2 400 out of coordinated APs to redirect STA 1 500 to maintain data continuity and in-service status of STA 1 500 (the STA 1 500 can be in stationary or mobility scenario). The AP 1 300 checks for any potential access point that matches the requirements of the STA 1 500 as illustrated at S903.

At 904, the AP 1 300 triggers the Redirect Indication/Redirect Confirmation about the same to AP 2 400. Further, at 905, the AP 1 300 sends Redirect Notify to the STA 1 500 including AP 2's available link(s) information. Followed by which the STA 1 500 shall read the AP 2's Beacon or Probe Response to get its required BSS information.

At 906, the STA 1 500 sends Redirect Request to AP 2 400 to initiate data handover including Link Reconfiguration Request. The AP 2 400 and AP 1 300 perform enhanced context transfer including SN, PN per TID, BA agreement, Security, etc. Further, the AP 2 400 sends Redirect Response to the STA 1 500 to conclude data handover including Link Reconfiguration Response. The STA 1 500 gets affiliated with the AP 2 400 and is in active data transmission.

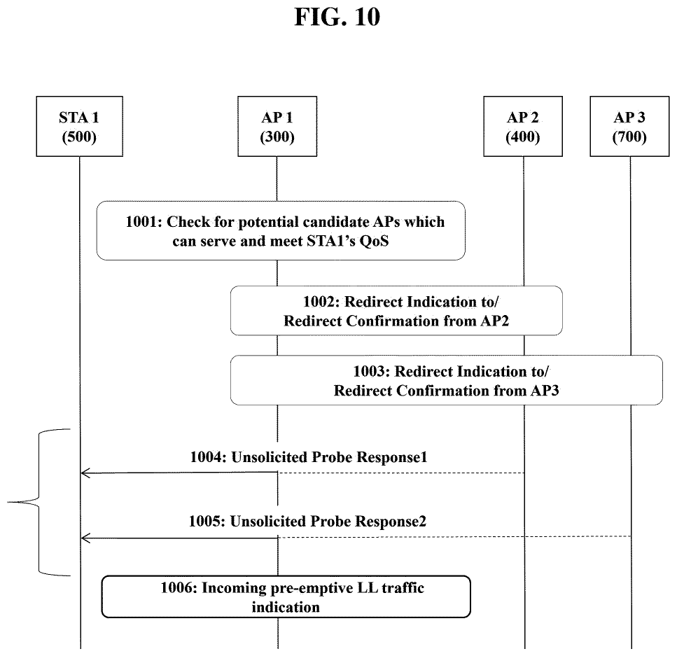

FIG. 10 is a sequence diagram that illustrates further optimizations to redirect the STA to AP2 according to the embodiments as disclosed herein.

In FIG. 9, steps 904 and 905 can be further optimized in terms of processing time, message size, and overall reduction in redirection procedure signaling latency by doing pre-processing related to Redirect Indication/Confirmation with the potential APs and pre-saving the potential AP's Unsolicited Probe Response equivalent configuration at the STA (by serving AP) before the start of the TT duration as shown in FIG. 10. Then, during the pre-emptive LL traffic-related TT event trigger, the STA can be redirected to one of those candidate APs.

At 1001 of FIG. 10, the serving access point verifies the neighbor access point 400 which can serve and meet the first station's 500 QOS before the arrival of the event. The serving access point 300 verifies the supported links, supported bandwidth, supported number of spatial streams, supported MCS, among others. Once the AP 1 300 finds the potential neighbor access point 400, the Redirect Indication is sent to the AP 2 400 for which the AP 2 400 responds with the Redirect Confirmation as shown in 1002. Also, the AP 1 300 searches for other neighbor access points that meet the required QoS. Once the other potential access points are found, the AP 1 300 transmits the Redirect Indication and receives the Redirect Confirmation in return from the other neighbor access points, e.g., AP 3 700 as shown in 1003.

At 1004, the AP 1 300 transmits the unsolicited probe response 1 comprising the information on the AP 2 400 to the STA 1 500. The unsolicited probe response includes the information included in the beacon frame, like network details needed for association. This method reduces the latency. Further, the AP 1 (300) transmits the unsolicited probe response 2 comprising the information on the AP 3 700 to the STA 1 as illustrated at 1005.

At 1006, the occurrence of the pre-emptive LL traffic is illustrated during which the STA is redirected to either neighbor APs (AP 2 or AP 3).

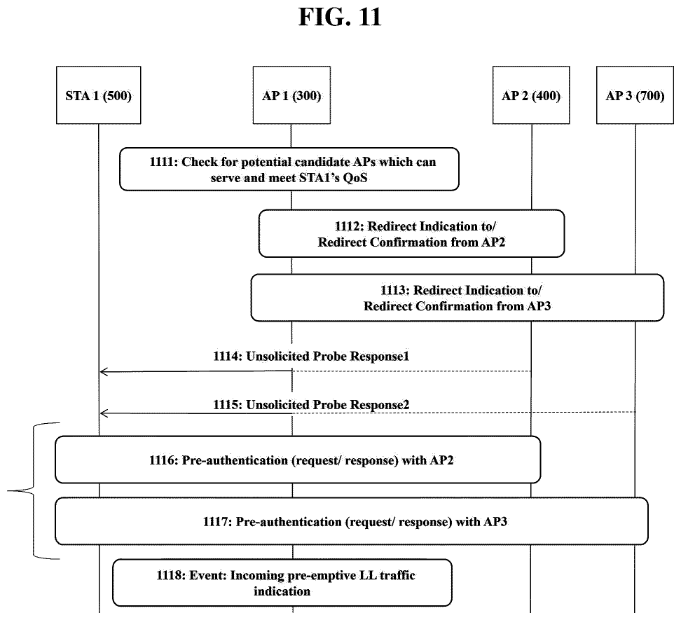

FIG. 11 is a sequence diagram that illustrates further optimizations to redirect a STA to AP2 according to the embodiments as disclosed herein. In FIG. 9, steps 906, 907, and 908 can be further optimized in terms of processing time, message size, and overall reduction in redirection procedure signaling latency by doing a pre-authentication of the STA with the potential APs before the start of the TT duration, as shown in FIG. 11. Then, during the pre-emptive LL traffic-related TT event trigger, the STA can be redirected to one of those candidate APs.

At 1111, AP1 300 checks for potential candidate APs that can serve and meet the QoS of the STA1 500.

At 1112, AP1 300 transmits a redirect indication to a candidate AP, AP2 400 to request for admitting client device (STA 1) that needs offloading. AP1 300 receives a redirect confirmation from AP2 400 as an acknowledgement of receiving the redirect indication.

At 1113, AP1 300 transmits a redirect indication to an another candidate AP, AP3 700 to request for admitting client device (for example, STA1 500) that needs offloading. AP1 300 receives a redirect confirmation from AP3 700 as an acknowledgement of receiving the redirect indication.

At 1114 and 1115, AP1 300 may receive an unsolicited probe response 1 from AP2 400 and/or receive an unsolicited probe response 1 from AP3 700.

At 1116 and 1117, there may be a pre-authentication procedure for the STA1 500 with the potential APs such as AP2 400 and AP3 700.

At 1118, during the pre-emptive LL traffic-related TT event trigger, the STA1 500 can be redirected to one of those candidate APs.

In an embodiment, a couple of new messages are introduced. Below are the message format details for each:

1) Redirect Indication: sent by AP1 to candidate AP2 to request for admitting client device (STA 1) that needs offloading and shall contain below, but not limited to, parameters:

{

| | |
|---|---|
| • | Coordination/ affiliation group ID: an ID that confirms both APs belonging to a |
| | form of coordinated/ affiliated/ trusted group based on any of the existing |
| | coordination schemes, |
| • | Cause value: the reason for offloading STA1 from AP1 to AP2 such as “LL traffic” |
| • | Client device (STA1) information : |
| | • Capability : STA1's capability support for Links, NSS, MCS, BW etc. |
| | • QoS requirements : STA1's ongoing data session QoS requirement. |

}

2) Redirect Confirmation: sent by AP2 to serving AP1 as an acknowledgement of receiving Redirect Indication and shall contain below, but not limited to, parameters:

{

| | |
|---|---|
| • | Coordination/ affiliation group ID: reciprocating same ID that confirms both APs |
| | belonging to a form of coordinated/ affiliated/ trusted group based on any of the |
| | existing coordination schemes |
| • | Result: using client information shared by AP1, an AP2 can decide to Accept or |
| | Reject the offloading of STA1 based on AP2's ability to support required QoS at |
| | this time |

}

3) Redirect Notify: sent by serving AP1 to STA1 (to be offloaded) and shall contain below, but not limited to, parameters:

{

| | |
|---|---|
| • | Candidate AP ID: APID of AP2 |
| • | Link(s) information: available link(s) as confirmed by AP2 to AP1 in Redirect |
| | Confirmation message |
| • | Beacon timing information (optional): Unless AP1 is including AP2's Unsolicited |
| | Probe Response (as proposed in further optimizations-1) within Redirect Notify, it |
| | may include this optional field to at least aid STA1 to read AP2's BSS broadcast |
| | quickly. |

}

4) Redirect Request:
sent by STA1 to AP2 and mainly contains enhanced Link Reconfiguration Request including link(s) requested as received via Redirect Notify, to initiate re-association with AP2.

Further Redirect Request/Response sequence will be further optimized if proposal from further optimizations are taken into consideration for doing a pre-authentication with the candidate AP(s) in advance.

5) Redirect Response:
After receiving Redirect Request from STA1, AP2 and AP1 shall engage in current data session context sharing for setting up data path on AP2 quickly for STA1.
Upon successfully setting up data path for current context and requested link(s), AP2 shall confirm STA1 about data path movement via Redirect Response containing enhanced Link Reconfiguration Response as well.

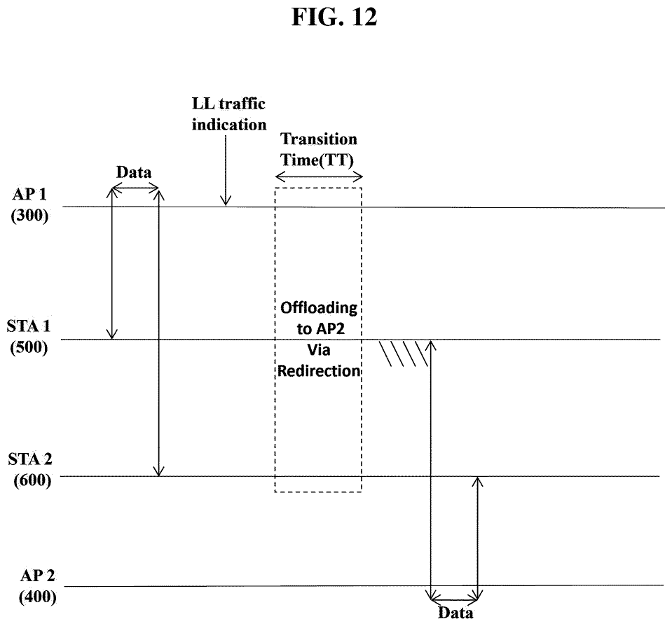

FIG. 12 illustrates a use case of the proposed method according to the embodiments as disclosed herein. The figure illustrates a scenario where the STA 1 500 is in an active data session with a peer STA 2 600 via AP 1 300. Further, the AP 1 receives an interrupt request such as LL traffic indication from a third client device. It is determined that the interrupting LL traffic is associated with the higher priority LL traffic than the STA1-STA 2 peer traffic. Within the TT, AP 1 300 processes the complete redirection procedure where the STA 1-STA 2 peers are offloaded to the AP 2 400 through the redirection. Further, the AP 2 400 performs the transmission of the ongoing traffic associated with the STA 1 500 and peer STA 2 600.

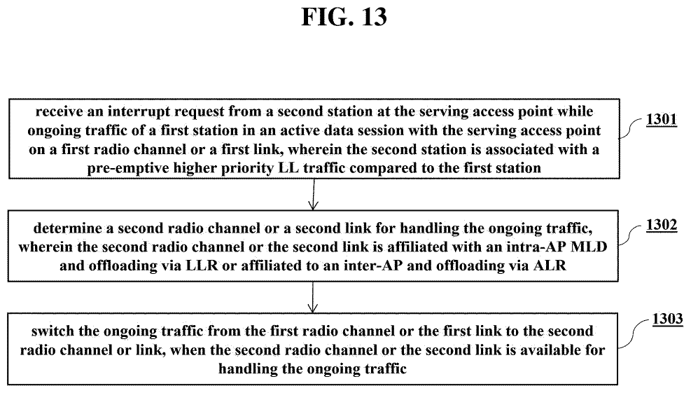

FIG. 13 is a flow diagram that illustrates the method for handling low latency (LL) traffic by switching the ongoing traffic from the first radio channel or the first link to the second radio channel or link by the serving access point according to the embodiments as disclosed herein.

At 1301, the serving access point 300 receives an interrupt request from the second station 600 at the serving access point 300 while ongoing traffic of the first station 500 in an active data session with the serving access point 300 on a first radio channel or the first link. The second station 600 is affiliated with a pre-emptive higher priority LL traffic compared to the first station 500.

Further, the serving access point 300 determines the second radio channel or the second link for handling the ongoing traffic as illustrated at 1302. The second radio channel or the second link is affiliated with an intra-AP MLD and offloading via the LLR or affiliated with an inter-AP and offloading via the ALR.

Further, at 1303, the pre-emptive LLT controller switches the ongoing traffic from the first radio channel or the first link to the second radio channel or the second link when the second radio channel or the second link is available for handling the ongoing traffic.

In an embodiment, the serving access point 300 determines the availability of data session context at an UMAC layer of the intra-AP MLD to utilize the second radio channel or the second link to continue the data session. Further, the serving access point 300 sends the LLR message to the first station 500. The LLR message includes an element for link re-configuration to move the active data session of a TID from the first radio channel or the first link to the second radio channel or the second link after a padding delay. The serving access point 300 redirects the active data session from the first radio channel or the first link to the second radio channel or the second link and uses the first radio channel or the first link for serving the higher priority LL traffic, whereas the second radio channel or the second link is used for continuing the active data session.

The serving access point 300 detects the neighbor access point 400 associated with the second radio channel or the second link based on the plurality of parameters. The neighbor access point 400 agrees to serve the first station 500. The serving access point 300 exchanges the mutual redirect indication and redirect confirmation between the serving access point 300 and the neighbor access point 400 associated with the second radio channel or the second link. Further, the serving access point 300 sends the redirect notify message to the first station 500 to redirect to the neighbor access point 400. The serving access point 300 serves the higher priority LL traffic of the second station 600 and migrates the first station 500 to the neighbor access point 400 for continued service of its ongoing data session. Simultaneously, the serving access point 300 serves the first station 500 via redirection to the neighbor access point 400 for active data continuity and the second station 600 in parallel without impacting a transmission opportunity (TXOP) of the serving access point 300.

In an embodiment, the plurality of parameters includes the collocation and affiliation to the same trusted domain, a power cycle or active state, and a radio channel capability. The radio channel capability comprises one or more of a link support information, number of spatial streams, MCS, mechanism(s) of data session context transfer, and security key exchange between the APs. The data session context between the first station 500 and the serving access point 300 comprises one or more of a sequence number (SN), a packet number (PN) per TID, Block Ack (BA) agreement, and security key fetching elements.

In an embodiment, the serving access point 300 determines the potential neighbor access point 400 from a plurality of neighbor access points 400 based on the Quality of Service (QOS) of the first station 500. Further, the serving access point 300 transmits the redirect indication message to at least one neighbor access point 400 to indicate a data session context between the first station 500 and the serving access point 300. The redirect indication message comprises one or more of a coordination group id, a cause value, and first station 500 information. The serving access point 300 receives the redirect confirmation message from the neighbor access point 400 indicating the confirmation of receiving the redirect indication message. The redirect confirmation message includes the coordination group id and a result indicating an accept or reject. The serving access point 300 detects the interrupt request indicating incoming pre-emptive low latency traffic from the second station 600 on the first radio channel or the first link while the ongoing traffic of the first station 500 is active on the first radio channel or the first link.

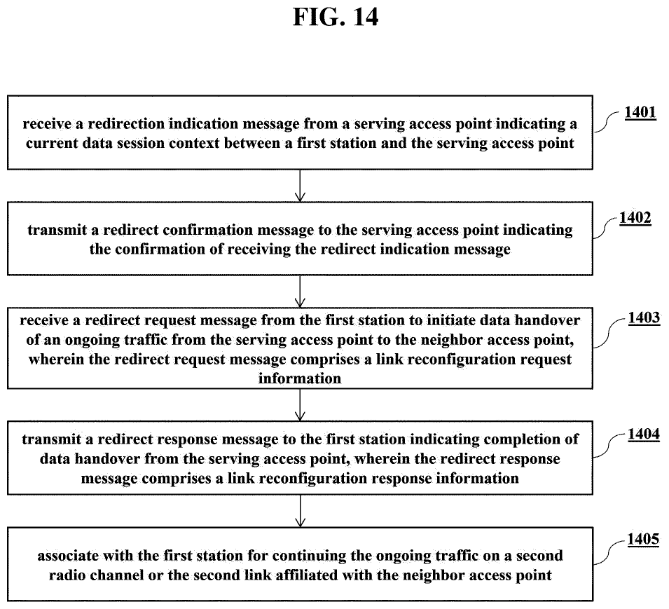

FIG. 14 is a flow diagram that illustrates the method for handling low latency (LL) traffic by associating with the first station for continuing the ongoing traffic on a second radio channel or the second link affiliated with the neighbor access point according to the embodiments as disclosed herein.

At 1401, the neighbor access point 400 receives the redirection indication message from the serving access point 300 indicating the current data session context between a first station 500 and the serving access point 300. The neighbor access point 400 transmits the redirect confirmation message to the serving access point 300 indicating the confirmation of receiving the redirect indication message and receives the redirect request message from the first station 500 to initiate data handover of ongoing traffic from the serving access point 300 to the neighbor access point 400 as illustrated at 1402. The redirect request message includes link reconfiguration request information.

At 1403, the neighbor access point 400 receives a redirect request message from the first station 500. The redirect request message indicates data handover of an ongoing traffic from the serving access point 300 to the neighbor access point 400. The redirect request message comprises a link reconfiguration request information.

At 1404, the neighbor access point 400 transmits a redirect response message to the first station 500. The message indicates completion of data handover from the serving access point 300. The redirect response message comprises a link reconfiguration response information.

At 1405, the neighbor access point 400 associates with the first station 500 for continuing the ongoing traffic on a second radio channel or the second link affiliated with the neighbor access point 400.

The proposed solution is applicable to any individual STA whose other end peer STA entity may be anywhere on the internet outside the serving BSS. The application is also applicable to the case where both/more peer STA entities might be within the same serving BSS system/AP1, such as a smart remote/phone controlling other smart appliances connected within the same home Wi-Fi with bi-directional data flow (e.g., a PC on Wi-Fi giving continuous printer commands to a printer while both are connected to the same Wi-Fi). In such a case as well, the same solution can be extended and both the peer STAs can be redirected to another AP2 in the event of pre-emptive LL traffic data.

An intra-AL MLD offloading mechanism via link-level redirection upon the event of pre-emptive LL traffic on a channel is proposed. Further, in an embodiment, the inter-AP offloading via AP-level redirection upon the event of pre-emptive LL traffic on a channel is described.

In an embodiment, an overall messaging flow to realize AP-level redirection, a scheme to identify the suitable candidate AP(s) for redirection, an enhanced context exchange with the candidate AP for redirection, and a transition time window concept to realize AP-level redirection efficiently is described. Furthermore, the detailed signaling mechanism for inter-AP level redirection of STA optimization(s) to the proposed signaling mechanism, the message format(s) for newly proposed messages within the redirection sequence is proposed.

The intent of pre-emption-based solutions (being researched in WiFi8) to handle LL traffic is to be able to provide the channel resource and serve the LL sensitive traffic as soon as possible, but performing pre-emption as such has definite trade-offs involved leading to multiple other issues which do have significant repercussions. Some such issues are listed in the problem statement. To solve those sets of problems, we propose a novel method to handle the pre-emptive LL traffic in alternate ways while leveraging the generic elements of M-AP coordination and roaming solutions with the overall aim to minimize the latency of service, meet the QoS, adhere to the power cycle, and optimize channel utilization.

The invention addresses the problem associated with pre-emption procedures by providing alternate methods to handle normal priority and lower priority traffic in the presence of pre-emptive high priority and low latency traffic on the channel. These methods aim to minimize service latency, meet Quality of Service (QOS) requirements, prevent Transmission Opportunity (TXOP) extension, adhere to power cycles, and optimize channel utilization.

Many industry contributions focus on pre-emption-based solutions to manage low latency (LL) traffic, ensuring channel resources are allocated to serve LL-sensitive traffic promptly. However, pre-emption introduces trade-offs that lead to significant issues. This invention aims to resolve the problems generated by such pre-emptive solutions.

The current pre-emptive solutions often neglect lower priority traffic, causing various issues such as implementation overhead, latency extension for pre-empted LL traffic, TXOP extension, channel unavailability for other users, and increased power consumption.

To avoid issues caused by pre-emptive traffic, the invention proposes intra-AP MLD offloading mechanisms and inter-AP MLD offloading mechanisms for pre-empted traffic. Detailed claims are provided for each step of the overall signaling flow, including candidate AP identification, context exchange, transition time windows, further signaling optimizations, and related message formats.

The foregoing description of the specific embodiments will so fully reveal the general nature of the embodiments herein that others can, by applying current knowledge, readily modify and or adapt for various applications such specific embodiments without departing from the generic concept, and, therefore, such adaptations and modifications are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

What is claimed is:

1. A method of a wireless communication performed by a serving access point (AP), comprising:
receiving, while ongoing traffic of a first station is in an active data session with the serving AP on a first radio channel or a first link, an interrupt request from a second station, wherein the second station is associated with a pre-emptive higher priority LL traffic compared to the first station;
determining a second radio channel or a second link for processing the ongoing traffic, wherein the second radio channel or the second link is affiliated with an intra-AP multi-link device (MLD) and offloading via the link level redirection (LLR) or affiliated with an inter-AP and offloading via AP level redirection (ALR); and
switching the ongoing traffic from the first radio channel or the first link to the second radio channel or second link, when the second radio channel or the second link is available for processing the ongoing traffic.

2. The method of claim 1, wherein the switching comprises:
determining an availability of data session context at an upper media access control (UMAC) layer of the intra-AP MLD to utilize the second radio channel or the second link to continue the data session;
transmitting an LLR message to the first station, wherein the LLR message comprises an element for link re-configuration to move the active data session of a traffic Identifier (TID) from the first radio channel or the first link to the second radio channel or the second link after a padding delay; and
redirecting the active data session from the first radio channel or the first link to the second radio channel or the second link.

3. The method of claim 2, wherein the switching further comprises:
using the first radio channel or the first link for serving the higher priority LL traffic; and
using the second radio channel or the second link for continuing the active data session.

4. The method of claim 1, wherein the switching comprises:
detecting a neighbor access point (AP) associated with the second radio channel or the second link based on a plurality of parameters, wherein the neighbor AP serves the first station;
exchanging mutual redirect indications and redirect confirmations between the serving access point and the neighbor AP associated with the second radio channel or the second link;
transmitting a redirect notify message to the first station to redirect the ongoing traffic to the neighbor AP;
serving the higher priority LL traffic of the second station;
migrating the first station to the neighbor AP for continued service of its ongoing data session; and
simultaneously serving the first station via redirection to the neighbor AP for active data continuity and the second station in parallel without impacting a transmission opportunity (TXOP) of the serving AP.

5. The method of claim 4, wherein the plurality of parameters comprises one or more of a collocation and affiliation to same trusted domain, a power cycle or active state, and a radio channel capability.

6. The method of claim 5, wherein the radio channel capability comprises one or more of a link support information, number of spatial streams, MCS, mechanism(s) of data session context transfer and security key exchange between the APs.

7. The method of claim 6, herein the data session context between the first station and the serving AP comprises one or more of a sequence number (SN), a packet number (PN) per traffic Identifier (TID), Block Ack (BA) agreement and security key fetching elements.

8. The method as claimed in claim 1, wherein the receiving comprises:
determining at least one potential neighbor AP from a plurality of neighbor APs based on Quality of Service (QOS) of the first station;
transmitting a redirect indication message to the at least one neighbor AP to indicate a data session context between the first station and the serving AP, wherein the redirect indication message comprises one or more of a coordination group id, a cause value, and a first station information;
receiving a redirect confirmation message from the at least one neighbor AP indicating the confirmation of receiving the redirect indication message, wherein the redirect confirmation message comprises one or more of a coordination group id, and a result indicating an accept or reject; and
detecting the interrupt request indicating incoming pre-emptive low latency traffic from the second station on the first radio channel or the first link while the ongoing traffic of a first station is active on the first radio channel or the first link.

9. A serving access point (AP) in a wireless network, comprising:
at least one processor including processing circuitry; and
memory storing information of a first station and a second station in the wireless network,
wherein the memory stores instructions that, when executed by the at least one processor individually or collectively, cause the serving AP to:
receive an interrupt request from the second station while ongoing traffic of the first station in an active data session with the serving AP on a first radio channel or a first link, wherein the second station is associated with a pre-emptive higher priority LL traffic compared to the first station;
determine a second radio channel or a second link for processing the ongoing traffic, wherein the second radio channel or the second link is affiliated with an intra-AP Multi-Link Device (MLD) and offloading via link level redirection (LLR) or affiliated with an inter-AP and offloading via AP level redirection (ALR); and
switch the ongoing traffic from the first radio channel or the first link to the second radio channel or the second link, when the second radio channel or the second link is available for processing the ongoing traffic.

10. The serving AP of claim 9, wherein, to switch the ongoing traffic, the instructions that, when executed by the at least one processor individually or collectively, cause the serving AP to:
determine an availability of data session context at an upper media access control (UMAC) layer of the intra-AP MLD to utilize the second radio channel or the second link to continue the data session;
transmit an LLR message to the first station, wherein the LLR message comprises an element for link re-configuration to move the active data session of a traffic Identifier (TID) from the first radio channel or the first link to the second radio channel or the second link after a padding delay; and
redirect, the active data session from the first radio channel or the first link to the second radio channel or the second link.

11. The serving AP of claim 9, wherein, to switch the ongoing traffic, the instructions that, when executed by the at least one processor individually or collectively, further cause the serving AP to:
use the first radio channel or the first link for serving the higher priority LL traffic; and
use the second radio channel or the second link for continuing the active data session.

12. The serving AP of claim 9, wherein, to switch ongoing traffic, the instructions that, when executed by the at least one processor individually or collectively, cause the serving AP to:
detect a neighbor access point (AP) associated with the second radio channel or the second link based on a plurality of parameters, wherein the neighbor AP serves the first station;
exchange mutual redirect indications and redirect confirmations between the serving AP and the neighbor AP associated with the second radio channel or the second link;
transmit a redirect notify message to the first station to redirect the ongoing traffic to the neighbor AP;
serve the higher priority LL traffic of the second station;
migrate the first station to the neighbor AP for continued service of its ongoing data session; and
simultaneously serve the first station via redirection to the neighbor AP for active data continuity and the second station in parallel without impacting a transmission opportunity (TXOP) of the serving AP.

13. The serving AP of claim 12, wherein the plurality of parameters comprises one or more of a collocation and affiliation to same trusted domain, a power cycle or active state, and a radio channel capability.

14. The serving AP of claim 13, wherein the radio channel capability comprises one or more of a link support information, number of spatial streams, MCS, mechanism(s) of data session context transfer and security key exchange between the APs.

15. The serving AP of claim 14, wherein the data session context between the first station and the serving AP comprises one or more of a sequence number (SN), a packet number (PN) per traffic Identifier (TID), Block Ack (BA) agreement and security key fetching elements.

16. The serving AP of claim 9, wherein, to receive the interrupt request, the instructions that, when executed by the at least one processor individually or collectively, cause the serving AP to:
determine at least one potential neighbor AP from a plurality of neighbor APs based on Quality of Service (QOS) of the first station;
transmit a redirect indication message to the at least one neighbor AP to indicate a data session context between the first station and the serving AP, wherein the redirect indication message comprises one or more of a coordination group id, a cause value, and a first station information;
receive a redirect confirmation message from the at least one neighbor AP indicating the confirmation of receiving the redirect indication message, wherein the redirect confirmation message comprises one or more of a coordination group id, and a result indicating an accept or reject; and
detect the interrupt request indicating incoming pre-emptive low latency traffic from the second station on the first radio channel or the first link while the ongoing traffic of a first station is active on the first radio channel or the first link.

17. The serving AP of claim 9, wherein the at least one processor comprises a pre-emptive low latency traffic (LLT) controller.

18. A neighbor access point (AP) in a wireless network, comprising:
at least one processor including processing circuitry; and
memory storing instructions that, when executed by the at least one processor individually or collectively, cause the neighbor AP to:
receive a redirection indication message from a serving AP indicating a current data session context between a first station and the serving AP on a first radio channel or a first link;
transmit a redirect confirmation message to the serving AP indicating the confirmation of receiving the redirect indication message;
receive a redirect request message from the first station to initiate data handover of an ongoing traffic from the serving AP to the neighbor AP, wherein the redirect request message comprises a link reconfiguration request information;
transmit a redirect response message to the first station indicating completion of data handover from the serving AP, wherein the redirect response message comprises a link reconfiguration response information; and
associate with the first station for continuing the ongoing traffic on a second radio channel or a second link affiliated with the neighbor AP.
